(19) United States
(12) Patent Application Publication
(10) Pub. No.: US 2011/0063513 A1
(43) Pub. Date: Mar. 17, 2011

(54) SYSTEM AND METHOD FOR REDUCING VIDEO BLOCK ARTIFACTS

(75) Inventor: Mark Francis Rumreich, Indianapolis, IN (US)

(73) Assignee: SHENZHEN TCL NEW TECHNOLOGY LTD., Shekou, Shenzhen, Guangdong (CN)

(21) Appl. No.: 12/992,581

(22) PCT Filed: Jul. 16, 2008
(86) PCT No.: PCT/US08/70204

§ 371 Date: Nov. 12, 2010

(30) Foreign Application Priority Data
Jun. 13, 2008 (CN) 200810067695.X

(51) Int. Cl. H04N 5/21

(52) U.S. Cl. 348/607; 348/E05.077

(57) ABSTRACT

The disclosed embodiments relate to a system and method for reducing block artifacts in a video picture. Embodiments include a system that adaptively applies a smoothing of a video picture on a pixel by pixel basis depending on the level of detail surrounding the pixel. In embodiments an amount of smoothing of the pixel depends on the level of detail in the four quadrants surrounding the pixel and the contrast between the pixel and adjacent pixels.

### FIELD OF THE INVENTION

Embodiments of the present invention relate generally to video display systems. More specifically, present embodiments relate to a video display system and method for reducing block artifacts.

### BACKGROUND OF THE INVENTION

This section is intended to introduce the reader to various aspects of art, which may be related to various aspects of present embodiments that are described and/or claimed below. This discussion is believed to be helpful in providing the reader with background information to facilitate a better understanding of various aspects of embodiments of the present invention. Accordingly, it should be understood that these statements are to be read in this light, and not as admissions of prior art.

Many modern video technologies such as HDTV, satellite transmission, and DVDs make use of video compression. Video compression reduces the bandwidth required for transmission of digital video, and reduces the amount of memory space that the digital video occupies. A common video compression method used in many digital video systems is known as MPEG encoding. One drawback of MPEG encoding is that it tends to produce block artifacts, which are visible as blocks of uniformly colored pixels in an image or picture. Pixel blocks are particularly noticeable in areas of an image that are relatively uniform in color, such as a region of an image depicting a person's forehead or a blue sky.

### BRIEF DESCRIPTION OF THE DRAWINGS

Advantages of embodiments of the present invention may become apparent upon reading the following detailed description and upon reference to the drawings in which:

FIG. 1 is a block diagram of an electronic device in accordance with present embodiments;

FIG. 2 is a block diagram of an adaptive filtering system in accordance with present embodiments;

FIG. 3 is a functional schematic of a blend calculator in accordance with present embodiments; and

FIG. 4 is a functional schematic of a pixel blender in accordance with present embodiments.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

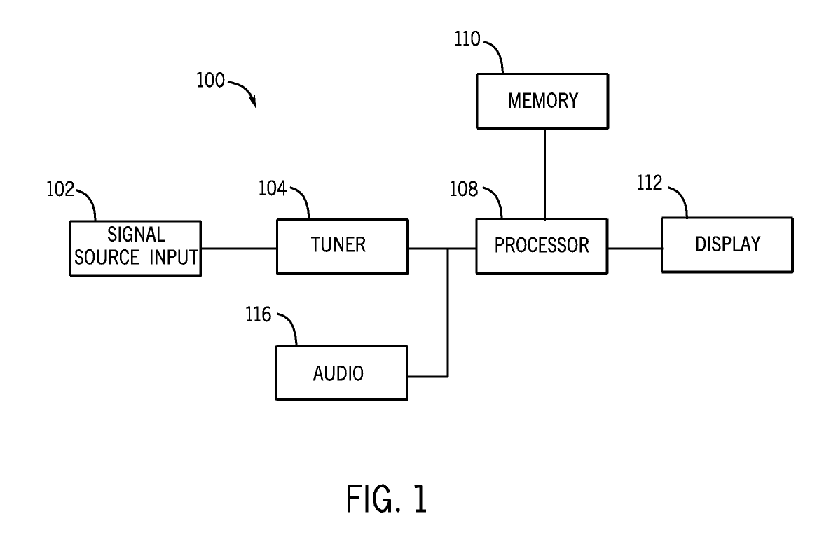

FIG. 1 is a block diagram of an electronic device in accordance with present embodiments. The electronic device is generally referred to by the reference number 100. The electronic device 100 (for example, a television, a portable DVD player or the like) comprises various subsystems represented as functional blocks in FIG. 1. Those of ordinary skill in the art will appreciate that the various functional blocks shown in FIG. 1 may comprise hardware elements (including circuitry), software elements (including computer code stored on a machine-readable medium) or a combination of both hardware and software elements.

A signal source input 102 may comprise an antenna input, an RCA input, an S-video input, a composite video input or the like. Those of ordinary skill in the art will appreciate that, although only one signal source is shown, the electronic device 100 may have multiple signal source inputs. The signal source input 102 may be adapted to receive a signal that comprises video data and, in some cases, audio data. In some embodiments, the signal source input 102 may be configured to receive a broadcast spectrum. For example, the signal source input 102 may comprise an antenna configured to receive a broadcast spectrum. In other embodiments, the signal source input 102 may be configured to receive a single channel of video and/or audio data. For example, the signal source input 102 may comprise a DVD player or the like.

A tuner subsystem 104 of the electronic device 100 may be adapted to tune a particular video program from a broadcast signal received from the signal input source 102. Those of ordinary skill in the art will appreciate that input signals that are not received as part of a broadcast spectrum may bypass the tuner 104 because tuning may not be required to isolate a video program associated with those signals. For example, input signals from a DVD may not need to be tuned.

A processor 108 of the electronic device 100 may be adapted to control general operation of the electronic device 100. The processor 108 may provide this operational control by cooperating with a memory 110 that is associated with the processor 108. The memory 110 may hold machine-readable computer code that causes the processor 108 to control the operation of the electronic device 100. Specifically, the memory 110 and the processor 108 may coordinate to perform methods and provide features in accordance with present embodiments based on computer-readable code stored on the memory 110.

The electronic device 100 may include a display subsystem 112. The display subsystem 112 may comprise a display, such as a liquid crystal (LCD) display, a liquid-crystal-on-silicon (LCOS) display, a digital light projection (DLP) display or any other suitable display type. The display subsystem 112 may include a lighting source (not shown) and other components that cooperate to generate a visible image on the display. Additionally, as indicated in the illustrated embodiment, the electronic device 100 may include an audio subsystem 116. The audio subsystem 116 may be adapted to play audio data associated with video data being displayed via the display subsystem 112. For example, the audio subsystem 116 may include speakers and an audio amplifier.

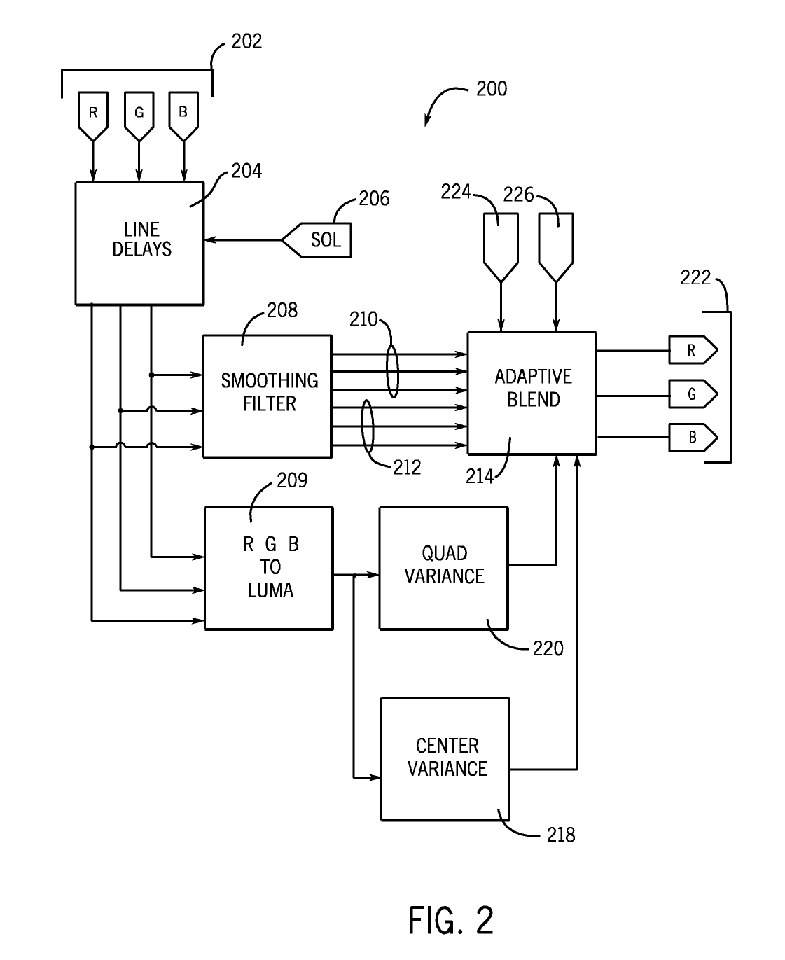

Turning now to FIG. 2, a block diagram depicts an adaptive filtering system in accordance with present embodiments. The adaptive filtering system is generally designated by reference number 200. This representative adaptive filtering system 200 is configured to receive decompressed video data, such as RGB data, as represented by video input 202. In the illustrated embodiment, the video input 202 includes three data lines that transmit the red, green and blue components of a video stream to the adaptive filtering system 200. For convenience, present embodiments are described as utilizing the RGB video format; however, it will be appreciated that embodiments may also utilize other video formats, such as YPrPb, for example.

Data received as the video input 202 is sent to a set of line delays 204, which capture several horizontal lines of video corresponding with the horizontal lines on a display, each line made up of several pixels. In some embodiments, the line delays 204 capture seven horizontal lines of pixels, with each pixel represented by an RGB code. Additionally, the line delays 204 may also receive an input signal 206 that acts as a “start of line” indicator, informing the line delay 204 when to begin capturing a line of data. The line delays 204 may send the seven lines of captured RGB data to a smoothing filter 208, and an RGB-to-luma converter 209.

The smoothing filter 208 may be configured to apply a formula that softens or blurs a video picture corresponding to the lines of data. For example, the smoothing filter may, for each color component, compute a weighted average of a center pixel and the surrounding pixels. Each color component of the center pixel may then be changed to the weighted average computed for that pixel. In this way, the center pixel effectively becomes a blend of the original color with the surrounding colors. This process may be repeated for each pixel in the captured video data. The weight given to particular pixels may vary depending on the level and style of smoothing desired in a particular embodiment. In one embodiment, the group of weighted pixels forms a diamond shape around the center pixel, and the center pixel is weighted equally with the surrounding pixels. The weighting technique set forth above may produce a high degree of blurring, especially at an intersection between four block artifacts.

In the illustrated embodiment, the smoothing filter 208 then sends the filtered RGB data to the adaptive blend block 214 via data lines 210 and also sends the original unfiltered RGB data to the adaptive blend block 214 via data lines 212. Because the filtered data may be time-delayed by the filtering computation, the original unfiltered RGB data may also be time delayed, such as by one or more D flip-flops, to enable both the filtered and unfiltered RGB data to emerge from the smoothing filter time-aligned. As will be explained in more detail below, the adaptive blend block 214 is configured to blend the filtered and unfiltered data pixel-by-pixel according to how much detail surrounds a particular pixel.

As indicated in FIG. 2, the RGB-to-luma converter 209 also receives the RGB data captured by the line delays 204. The RGB-to-luma converter 209 may be configured to compute brightness or “luma” values from the RGB data for each pixel according to a formula well known in the art. The luma values may then be sent to both a center variance calculator 218 and a quad variance calculator 220, both of which calculate a coefficient for each pixel representing the level of detail around the pixel.

The center variance calculator 218 may be configured to calculate a center variance, which represents the level of detail immediately surrounding a pixel. For purposes of the present description, the “center pixel” shall refer to the pixel for which a variance coefficient is calculated. In an embodiment, the center variance is calculated from the center pixel, the two pixels above the center pixel, the two pixels below the center pixel, the two pixels to the right of the center pixel, and the two pixels to the left of the center pixel. Specifically, the center variance may be calculated by summing the absolute brightness difference between each adjacent pair of pixels within the group of pixels described above. The output of the center variance calculator 218 may be an unsigned eight-bit number that varies from 0 to 255, representing the calculated center variance.

The quad variance calculator 220 may be configured to calculate a quad variance, which represents the level of detail found in four quadrants surrounding the center pixel. In an embodiment, the quad variance is calculated from four pixel blocks in the four quadrants surrounding the center pixel, each pixel block being 3 pixels high and four pixels wide. Specifically, the quad variance may be calculated by summing the absolute brightness difference between each adjacent pair of pixels within the group of pixels described above, including horizontal pairs and vertical pairs. Furthermore, in accordance with present embodiments, each block may be summed individually, and the quad variance made to equal the largest sum calculated for the four blocks. The output of the quad variance calculator 220 may be an unsigned eight-bit number that varies from 0 to 255, representing the calculated quad variance.

It will be appreciated that the particular embodiments described above for determining the level of detail surrounding a pixel are only representative embodiments, and other methods for calculating a parameter representing the level of detail around a pixel are also within the scope of embodiments of the present invention.

Returning to the adaptive blend block 214, in accordance with present embodiments, the adaptive blend block 214 may be configured to use both the quad variance and the center variance as measures of the level of detail around each pixel. In the illustrated embodiment, the adaptive blend block 214 generates a video output 222 that may be utilized to provide an image, such as on the display 112. The video output 222 may include a stream of RGB encoded output pixel data that is a combination of the filtered RGB data and the time-aligned unfiltered RGB data. Specifically, each output pixel may include a filtered pixel, an unfiltered pixel, or a blend of the filtered and unfiltered pixel depending on the quad variance and the center variance. In this way, a different level of filtering may be applied to each pixel, dependent upon the level of detail around the pixel as quantified by the quad variance and the center variance. In one embodiment, an output pixel may be equal to the unfiltered pixel if the quad variance and/or the center variance are above a specified threshold, and equal to the filtered pixel if the quad variance and the center variance are below a specified threshold. In another embodiment, the output pixel may be generated by calculating a weighted blend of the filtered pixel and unfiltered pixel, with the weighting determined by the quad variance and the center variance.

It is important to note that embodiments employing both the quad variance and the center variance, rather than either one individually, may provide a higher level of block artifact reduction. Using only the quad variance may smooth both strong and weak block boundaries, which may be undesirable because strong block boundaries likely indicate actual picture detail. Using only the center variance, on the other hand, may inhibit the smoothing of weak block boundary transitions, because without a measure of the level of detail in the general vicinity of the target pixel, which the quad variance provides, smoothing will generally be limited to areas of very low center variance to avoid filtering out low-contrast picture details.

The adaptive filtering system 200 may also include user inputs configured to selectively adjust the level of filtering. For example, the adaptive filtering system 200 may include adjustable user inputs such as a center variance gain 226 and a variance gain 224, both of which may be used to increase or decrease a level of filtering applied to a video picture depending on the preference of the user, as will be described in more detail below.

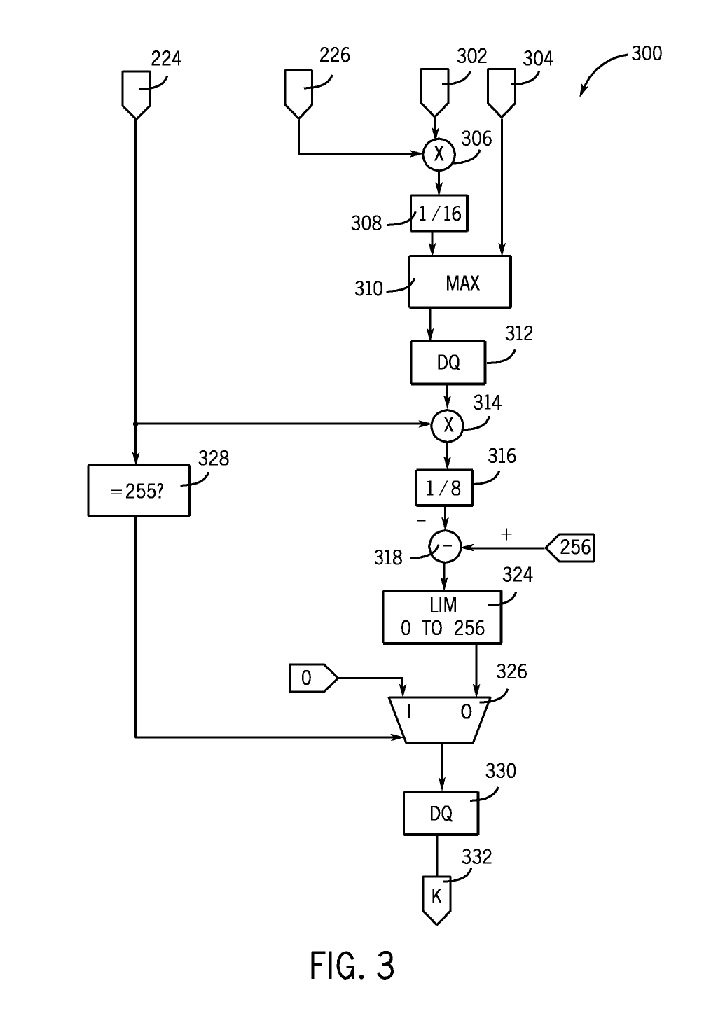

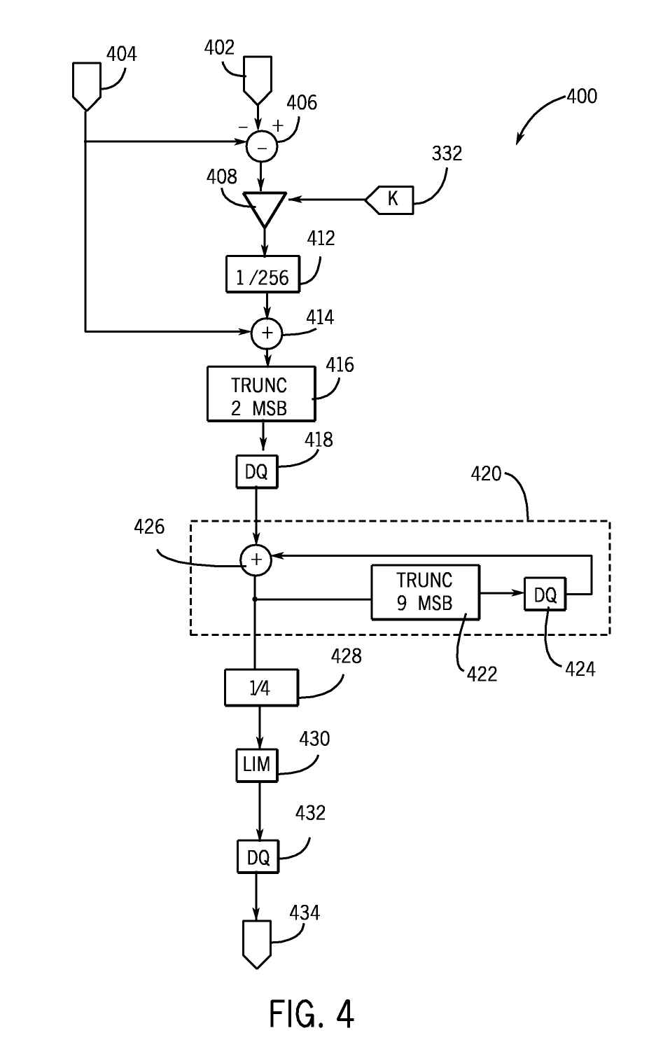

Turning now to FIG. 3 and FIG. 4, functional schematics of representative circuits within the adaptive blend block 214 employing a weighted blending technique in accordance with present embodiments are shown. As will be described further below, FIG. 3 is a functional schematic of a “blend calculator,” which is configured to determine a coefficient “K,” or “K-value,” corresponding with the level of filtering to be applied for a particular pixel based on the center variance and the quad variance calculated for that pixel. FIG. 4 is a functional schematic of a “pixel blender,” which is configured to determine an output pixel based on the filtered pixel, the unfiltered pixel and the K-value determined for the pixel. It should be noted that each color component of the RGB data may be processed simultaneously by three circuits of the kind described in FIG. 4, utilizing the same K-value calculated for the pixel.

Referring to FIG. 3, a functional schematic of a blend calculator 300 in accordance with present embodiments is shown. The blend calculator 300 is configured to calculate the K-value based on four input values: a center variance 302, the center variance gain 226, the quad variance 304, and the variance gain 224. In some embodiments, the input values include 8-bit unsigned binary numbers. The center variance 302 may be multiplied by the center variance gain 226 via a multiplier 306. Then the product may be divided by sixteen via a divider 308. In effect, the divider 308 may be configured to apply a built in gain adjustment to the center variance 302. Although a gain of one-sixteenth is shown, in some embodiments, the actual gain value may be altered depending on the visual characteristics desired. In some embodiments, the divider 308 may be eliminated.

The output of the divider 308 and the quad variance may then be compared by a comparator 310, which may be configured to output the largest of the two values. The output of the comparator 310 may be sent to a D flip-flop 312, which may store the output of the comparator for one clock cycle, thereby delaying the output by one clock cycle.

Next, the output of the D flip-flop may be multiplied by the variance gain 224 via a multiplier 314. The product may then be divided by eight via a divider 316. The divider 316 effectively applies a built in gain adjustment to the overall variance value. Although a gain of one-eighth is shown, in some embodiments, the actual gain value may be altered depending on the visual characteristics desired. In some embodiments, the divider 316 may be eliminated.

Next, the output of divider 316 may be subtracted from two-hundred-fifty-six via a subtractor 318, which serves to bring the K-value into a desired range. In some embodiments, a different value may be used for subtractor 318, or alternatively the subtractor 318 may be eliminated. The output of the subtractor 318 may then be sent to a limiter 324, which restricts the output K-value to a number between zero and two hundred fifty-six.

The output of the limiter 324 may then be sent to a multiplexer 326, which serves as part of a circuitry configured to allow the user to disable the adaptive blending feature. Specifically, the multiplexer 326 may be configured to switch either the output of the limiter 326 or a value of zero to the output of the multiplexer 326. The selection between the two inputs may be controlled by a conditional operator 328 coupled to the variance gain 224. If the variance gain 224 is equal to two-hundred-fifty-five, the conditional operator 328 outputs a value of one to the multiplexer 326, and the output of the multiplexer switches to zero. Otherwise, the conditional operator 328 sends a zero to the multiplexer 326 and the output of the multiplexer is set to the value output by the limiter 324. The output of the multiplexer may then be sent to a D flip-flop, which holds the K-value for one clock cycle. One of ordinary skill in the art will appreciate that the circuitry described above will result in a K-value calculated by the following formula:

$$K = 256 - \frac{{G}_{V}}{8} ( max ( {V}_{Q} , \frac{{G}_{C}}{16} \cdot {V}_{C} ) )$$

Where V_{Q} is the quad variance; V_{C} is the center variance; G_{V} is the variance gain; and G_{C} is the center variance gain. The resulting K-value output 332 is then sent to a pixel blender 400, as illustrated in FIG. 4, wherein the K-value output 332 determines the weight given to the filtered pixel in a weighted blend of the filtered pixel and unfiltered pixel.

Referring to FIG. 4, a functional schematic of the pixel blender 400 in accordance with present embodiments is shown. The pixel blender 400 is configured to receive filtered pixel data 402 and unfiltered pixel data 404 from the smoothing filter 208 as described above. Both the filtered pixel data 402 and unfiltered pixel data 404 represent one of the color components of an individual pixel within the lines of captured RGB data. The adaptive blend block 214 illustrated in FIG. 2 may include three pixel blenders 400, with each color component simultaneously processed by one of the pixel blenders.

According to an embodiment, a difference between the filtered and unfiltered pixel values is calculated by the subtractor 406. The output of the subtractor 406 will, therefore, represent the level of filtering applied to the pixel by the smoothing filter 202. Next, amplifier 408 amplifies the output of the subtractor 406 by a factor equal to the K-value output 332 generated by the blend calculator 300. The output of the amplifier is then divided by two-hundred-fifty-six by the divisional operator 412. The resulting value output by the divisional operator 412 is then added to the unfiltered pixel data 404 by the adder 414. One of ordinary skill in the art will appreciate that the circuitry described above will result in a pixel color value, P, calculated by the following formula:

$$P = \frac{K}{256} ( F - U ) + U$$

Which may also be expressed in the following form:

$$P = \frac{K}{256} \cdot F + ( 1 - \frac{K}{256} ) \cdot U$$

Where F is the value of the filtered pixel; U is the value of the original or unfiltered pixel; and K is the K-value calculated by the blend processor 300. One of ordinary skill in the art will recognize that a K-value of two-hundred-fifty-six will result in the maximum smoothing, and a K-value of zero will result in no smoothing.

One of ordinary skill in the art will recognize that, as a result of the calculations performed by the pixel blender 400, the pixel data output from adder 414 may include additional bits beyond the original eight bits included in the input pixel data. In accordance with present embodiments, the pixel data output from adder 414 may include twelve bits. To reduce the twelve-bit result back into an eight-bit pixel, the pixel blender 400 may include circuitry that may round or truncate the twelve-bit binary number down to an eight-bit binary number. In some embodiments, the output of the adder 414 is truncated by a truncator 416. Specifically, the two most significant bits may be eliminated. This can be done without a loss of useful information because the two most significant bits of the output of the adder 414 will necessarily equal zero due to the nature of the calculations performed by the pixel blender circuitry 400. The result may then be output to a D flip-flop 418, which stores the result for one clock cycle.

Next, bypassing the recursive rounding routine 420 for now, the resulting ten-bit number may be reduced to an eight bit number by dividing the ten-bit number by four with the divider 428. One of ordinary skill in the art will recognize that dividing by four is the equivalent of truncating the two least significant bits, therefore some useful information may be lost in the process, possibly resulting in rounding errors that may appear on the display as jagged edges known as “stair-stepping” artifacts. To reduce the appearance of stair-stepping artifacts, embodiments may optionally include a recursive rounding routine 420 known to those of ordinary skill in the art. It should be noted that the adder 426 will increase the ten-bit number to an eleven bit number. The recursive rounding routine 420 includes a truncator 422 that truncates the 9 most significant bits, leaving the two least significant bits to be added back into the output of the D flip flop 418 by the adder 426 after one clock delay introduced by the D flip-flop 424. In this way, truncated pixel information is added back in to the next pixel, rather than being lost.

If a recursive rounding routine 420 is included in an embodiment, the output of the divider 428 will be a nine-bit number, rather than an eight bit number. Therefore, the output of the divider 428 may be sent to a limiter 430, which limits the number to an eight-bit value between zero and one-thousand-twenty-three. Specifically, any number larger than one-thousand-twenty-three will be reduced to one-thousand-twenty-three, and any number less than zero will be increased to zero.

The resulting pixel data is then stored in the D flip-flop 432 for one clock cycle before being sent to the display 112, along with the other color components calculated by the other pixel blenders 400, resulting in a full RGB encoded pixel being output to the display 112.

One of ordinary skill in the art will recognize various hardware components and configurations suitable for carrying out the calculations described above. For example, the calculations described above may be carried out by various discrete electronic circuitry including operational amplifiers, transistors, logic gates, etc., as will be appreciated by those of ordinary skill in the art. Additionally, the calculations described above may be computed by an integrated circuit or microprocessor.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A method comprising:
determining a smoothing value of a target pixel that corresponds with a function based on characteristics of the target pixel and pixels surrounding the target pixel;
determining one or more variance values corresponding with a level of picture detail surrounding the target pixel;
determining an amount of smoothing of the target pixel based on the smoothing value and the one or more variance values; and
providing an output pixel based on the amount of smoothing.

2. The method of claim 1, wherein the function is a weighted average of the target pixel and pixels surrounding the target pixel.

3. The method of claim 1, comprising decreasing the amount of smoothing of the target pixel in proportion to the one or more variance values.

4. The method of claim 1, comprising increasing the amount of smoothing of the target pixel if the one or more variance values are below a specified threshold.

5. The method of claim 1, wherein determining the one or more variance values comprises converting a color encoded pixel into a brightness encoded pixel.

6. The method of claim 1, wherein determining the one or more variance values comprises summing the absolute difference between adjacent pixels within a group of pixels surrounding the target pixel.

7. The method of claim 6, wherein the group of pixels comprises pixels directly above, directly below, directly to the left and directly to the right of the target pixel.

8. The method of claim 6, wherein the group of pixels comprises pixels immediately adjacent to the target pixel.

9. The method of claim 6, wherein the group of pixels comprises pixels within four quadrants surrounding the target pixel.

10. A method comprising:
determining a first variance between pixels in four quadrants surrounding a target pixel;
determining a second variance between the target pixel and pixels in a group bounding the target pixel; and
increasing an amount of smoothing of the target pixel if the first variance is below a first threshold and the second variance is below a second threshold.

11. The method of claim 10, wherein determining the first variance and the second variance comprises converting the target pixel, the pixels in four quadrants surrounding the target pixel and the pixels in the group bounding the target pixel into brightness data.

12. The method of claim 10, comprising applying a gain factor to the first variance and the second variance according to input from a user.

13. The method of claim 10, wherein the amount of smoothing of the target pixel is determined by a weighted average of the target pixel and a group of pixels surrounding the target pixel.

14. The method of claim 10, wherein the target pixel, the pixels in four quadrants surrounding the target pixel, and the pixels in the group bounding the target pixel are encoded as RGB data.

15. The method of claim 10, wherein each of the four quadrants comprises a rectangular block of approximately four to sixty-four pixels.

16. The method of claim 10, wherein the group of pixels bounding the target pixel comprises a group of approximately four to sixty-four pixels.

17. An electronic device, comprising:
a smoothing filter configured to generate a smoothed pixel based on a characteristic of a target pixel and a characteristic of a group of pixels surrounding the target pixel;
one or more variance generators configured to generate one or more variance values corresponding with picture detail surrounding the target pixel; and
an adaptive blend generator configured to generate a displayed pixel based on the characteristics of the target pixel, the characteristics of the smoothed pixel, and the variance values.

18. The electronic device of claim 17, wherein the one or more variance generators comprises both a quad variance generator and a center variance generator.

19. The electronic device of claim 17, wherein the displayed pixel equals the target pixel if the one or more variance values are above a specified threshold and the displayed pixel equals the smoothed pixel if the one or more variance values are below a specified threshold.

20. The electronic device of claim 17, wherein the displayed pixel equals a weighted blend of the target pixel and the smoothed pixel, and wherein the weight given to the target pixel versus the smoothed pixel is determined from the one or more variance values.

21. The electronic device of claim 17, wherein the electronic device comprises a digital television.

22. The electronic device of claim 17, wherein the pixels are encoded as RGB data.
